(19) United States
(12) Patent Application Publication
(10) Pub. No.: US 2017/0001239 A1
(43) Pub. Date: Jan. 5, 2017

(54) Vacuum Melting and Casting Apparatus

(71) Applicant: ULVAC, INC., Kanagawa (JP)

(72) Inventors: Seiji Tashiro, Kanagawa (JP); Youichi Oohinata, Kanagawa (JP); Naoki Hibino, Kanagawa (JP); Takashi Oowada, Kanagawa (JP)

(73) Assignee: ULVAC, INC., Kanagawa (JP)

(21) Appl. No.: 15/110,124

(22) PCT Filed: Feb. 10, 2015
(86) PCT No.: PCT/JP2015/000611

§ 371 Date: Jul. 7, 2016

(30) Foreign Application Priority Data
Mar. 27, 2014 (JP) 2014-065733

(51) Int. Cl. B22D 11/06; B22D 11/113; F27D 7/06; B22D 11/128; B22D 11/14; B22D 11/12; B22D 11/00; B22D 11/124

(52) U.S. Cl. CPC B22D 11/0697; B22D 11/001; B22D 11/0628; B22D 11/064; B22D 11/068; B22D 11/113; B22D 11/124; B22D 11/1284; B22D 11/141; B22D 11/12; F27D 7/06; F27D 2007/066

(57) ABSTRACT

A hermetically sealed container is equipped inside thereof with: a melting furnace; a cooling roll for subjecting the molten metal tapped from the melting furnace to primary cooling to form a casting; and a rotatable cooling drum which receives the casting formed by the cooling roll and which subjects the casting to secondary cooling. The cooling drum has: a tubular member elongated in one longitudinal direction and having a receiving opening which is formed to open on one side of the tubular member to receive therein the casting, and a discharge opening which is formed to open on an opposite side of the tubular member to discharge the casting that has been subjected to the secondary cooling; and a transfer means for transferring the casting received from the receiving opening toward the discharge opening in response to the rotation of the tubular member.

### TECHNICAL FIELD

The present invention relates to a vacuum melting and casting apparatus in which a metallic material is melted by a strip casting method to thereby form a casting (a half-finished product).

### BACKGROUND ART

This kind of vacuum melting and casting apparatus is known, for example, in Patent Document 1. The apparatus in question has, inside a hermetically sealed container to which an evacuating pipe and a gas introducing pipe are connected: a melting furnace; and a cooling roll which forms a casting by performing primary cooling of molten metal tapped from the melting furnace; and a cooling drum which is rotatable and receives the casting that is formed in the cooling roll, thereby performing secondary cooling. The cooling drum is constituted by a bottomed tubular member which is housed in a horizontal posture inside the hermetically sealed container. There is provided a water-cooling jacket on the peripheral surface of the bottomed tubular member. On the closed end on the bottom side of the cooling drum, a rotary shaft is protruded outside through a rotary seal portion. The rotary shaft is coupled to a motor through a belt. By means of the motor, the cooling drum is arranged to be rotatable in forward and reverse directions.

On the inner peripheral surface of the cooling drum, there is provided a spiral projecting strip. By rotating the cooling drum in forward direction, the casting is transferred by the projecting strip from the open end on one side of the cooling drum toward the side of the closed end. While the casting is being stored (held in stock) inside the cooling drum, the casting is cooled. Once predetermined amount of casting has been held in stock, the cooling drum is rotated in the reverse direction so that the casting that has been subjected to the secondary cooling is transferred to the side of the opening end so as to discharge it out of the opening end.

It is to be noted here that, since the casting that has been strip-cast is once entirely held in stock inside the cooling drum, the cooling drum itself must be made larger in size in view of the productivity. There is thus a problem in that the vacuum melting and casting apparatus is inevitably made larger in size. In addition, if the casting is once held in stock inside the cooling drum and subsequently subject the casting to cooling, there will occur a difference in the cooling speed of the casting between the position near the inner periphery of the cooling drum and the position far from the inner periphery thereof. Therefore, there is also a problem in that the entire casting cannot be subjected to secondary cooling substantially uniformly.

In case the casting is an alloy material for use in NdFeB sintered magnets, when the casting is subjected to the primary cooling by the cooling roll, the principal components will have been solidified. However, at primary cooling, part of the rare-earth components are present in the liquid phase, and they will be solidified at the time of secondary cooling. In this kind of case, as noted above, when there is a difference in the cooling speed, the solidification state of the rare-earth components will change and, consequently, the desired magnetic characteristics cannot be obtained when sintered magnets are obtained.

### PRIOR ART DOCUMENTS

### Patent Documents

Patent Document 1: WO 2011/067910 A1

### SUMMARY

### Problems to be Solved by the Invention

In view of the above, this invention has a problem of providing a vacuum melting and casting apparatus in which the casting can be substantially uniformly subjected to secondary cooling and in which downsizing of the apparatus is possible.

### Means of Solving the Problems

In order to solve the above-mentioned problems, a vacuum melting and casting apparatus according to this invention has, inside a hermetically sealed container to which an evacuating pipe is connected: a melting furnace; a cooling roll for forming a casting by subjecting molten metal tapped from the melting furnace to primary cooling; and a rotatable cooling drum for receiving the casting formed by the cooling roll and for subjecting the casting to secondary cooling. The vacuum melting and casting apparatus is characterized in that the cooling drum comprises: a tubular member elongated in one longitudinal direction and having a receiving opening which is formed to open on one side of the tubular member in order to receive therein the casting, and a discharge opening which is formed to open on an opposite side of the tubular member in order to discharge the casting that has been subjected to the secondary cooling; and a transfer means for transferring the casting received from the receiving opening toward the discharge opening in response to the rotation of the tubular member.

According to this invention, there is employed an arrangement: in which the casting received by the cooling drum is sequentially transferred from the receiving opening side toward the discharge opening side in response to the number of rotation of the cooling drum and; in which, as a result of heat exchanging with the inner peripheral surface of the cooling drum in the course of this transfer, the casting is subjected to the secondary cooling for further discharging out of the discharge opening. Therefore, unlike the above-mentioned conventional arrangement in which the casting is once stored, the casting can be substantially uniformly cooled. Further, by changing the number of rotation of the cooling drum, it also becomes possible to change the cooling speed. Still furthermore, without being bound by the productivity, the cooling drum may have the length and the inner diameter to suit the temperature to which the casting shall be cooled. Therefore, the downsizing of the cooling drum becomes possible. As a consequence, the downsizing of the vacuum melting and casting apparatus also becomes possible.

According to this invention, the transfer means preferably further comprises: a first projecting strip disposed spirally on an inner peripheral surface of the tubular member; and at least one second projecting strip disposed linearly on the inner peripheral surface of the tubular member. The casting received by the cooling drum can be prevented from staying locally inside the cooling drum. The casting can thus be efficiently and sequentially transferred from the receiving opening toward the discharge opening by a predetermined amount at a time.

Further, according to this invention, the vacuum melting and casting apparatus preferably further comprises a grinding means for grinding, before transferring to the receiving opening, the casting which has been subjected to primary cooling by the cooling roll. According to this arrangement, by grinding the casting down to a substantially uniform size prior to receiving it in the cooling roll, the strip-cast casting can be arranged down to a substantially uniform size. As a result, the casting can be subjected to secondary cooling more uniformly.

Further, by employing an arrangement in which the tubular member is further provided with a cooling gas introducing means for introducing a cooling gas to accelerate the secondary cooling of the casting inside the tubular member, the length and the diameter of the cooling drum can be made further smaller. As a result, further downsizing of the vacuum melting and casting apparatus becomes possible.

### BRIEF DESCRIPTION OF THE DRAWINGS

FIG. 1 is a schematic sectional view showing an arrangement of a vacuum melting and casting apparatus according to an embodiment of this invention.

FIG. 2 is a sectional view showing by enlarging an essential part of FIG. 1.

FIG. 3 is a side view of a transfer means disposed inside the cooling drum.

### MODES FOR CARRYING OUT THE INVENTION

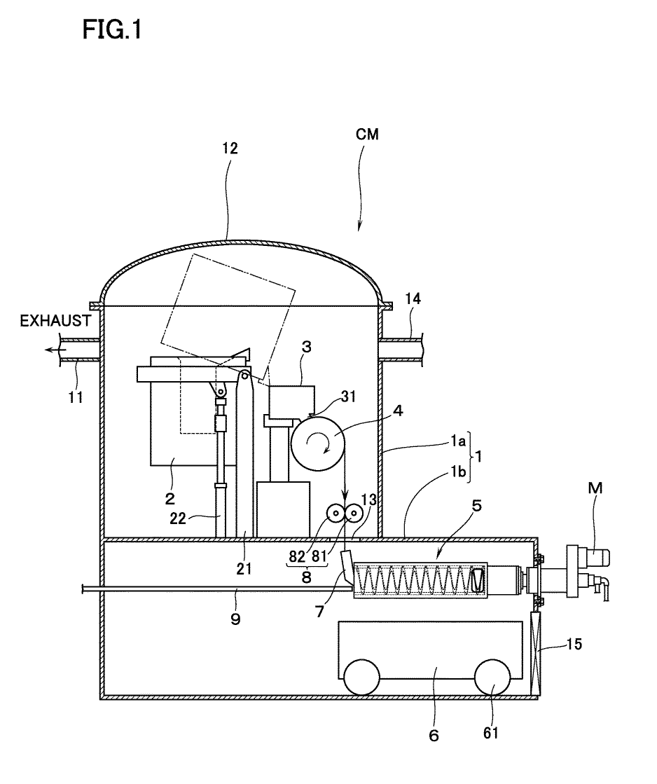

With reference to the drawings, explanation will now be made of an embodiment of a vacuum melting and casting apparatus according to this invention. In the following description, the terms showing the directions such as up, down, left and right are based on FIG. 1.

With reference to FIG. 1, reference mark CM is a vacuum melting and casting apparatus according to an embodiment of this invention. The vacuum melting and casting apparatus CM is provided with a hermetically sealed container (vacuum chamber) 1 to which is connected a vacuum exhaust pipe 11 from a vacuum pump (not illustrated). The hermetically sealed container 1 is constituted by a main container portion 1a in the shape of a vertical cylinder and a sub-container portion 1b of a horizontal cylinder disposed in communication with a lower part of the main container portion 1a. On an upper end of the main container portion 1a there is provided a cover member 12 that can be opened and closed. Further, the main container portion 1a contains therein a melting furnace 2, a tundish 3, and a cooling roll 4. The subsidiary container portion 1b contains therein a cooling drum 5 and a recovery box 6 whose upper surface is left open.

The melting furnace 2 is pivotally supported, at an upper end portion thereof, by a supporting column 21 which is vertically disposed inside the main container portion 1a. It is so arranged that the melting furnace can be tilted by cylinder 22 from an upward posture as shown by thick lines in FIG. 1 to a front-down inclined posture as shown by imaginary lines. In a state in which the cover member 12 is left open, a metallic material is charged into the melting furnace 2 in its upward posture. Thereafter, the cover member 12 is closed and the metallic material is melted by induction heating inside the melting furnace 2. Once the melting of the metallic material has been finished, the melting furnace 2 is tilted into an inclined posture so as to tap the molten metal in the melting furnace 2 into the tundish 3. As the metallic material, there can be pointed out alloy raw material such as for NdFeB sintered magnets.

The tundish 3 is in a box shape made of ceramic and is arranged to quantitatively strip-cast the molten metal onto the cooling roll 4 out of a laterally elongated slit that is provided in a nozzle 31 at the bottom surface of the tundish. The cooling roll 4 is arranged to rotate at a peripheral speed of 0.1 to 5.0 m/sec. The peripheral surface of the cooling roll is water-cooled from the inner portion thereof. The molten metal that has been strip-cast onto the cooling roll 4 is subjected to primary cooling on the peripheral surface of the cooling roll 4 and is solidified, and is thereafter peeled off from the cooling roll 4 as a thin band-like cast product.

In addition, the main container portion 1a has connected thereto a gas introduction pipe 14 which is communicated with a gas supply source such as an inert gas and the like. In melting the metallic material that has been charged into the melting furnace 2, the hermetically sealed container 1 is first evacuated by exhausting through the vacuum exhaust pipe 11. The gasifiable compositions such as moisture and the like that are contained in the metallic material are thus de-aerated. Thereafter, at a time when the metallic material has been melted to a certain degree, an inert gas is introduced through the gas introduction pipe 14 into the hermetically sealed container 1, thereby raising the internal pressure of the hermetically sealed container 1. Transpiration of the metallic material inside the melting furnace 2 is thus prevented. The casting: is then allowed to drop into the sub-container portion 1b through a discharge port 13 that is provided in the main container portion 1a and the sub-container portion 1b, respectively, at a position below the cooling roll 4; is dumped into the cooling drum 5 through a trough 7 that is disposed inside the sub-container 1b so as to be inclined downward toward the right side; and is subjected to secondary cooling inside the cooling drum 5. In this case, in a dropping path of the casting from the cooling roll 4 into the discharge port 13 inside the main container portion 1a, there is provided a grinding means 8 made up of a pair of rollers 81, 82. It is thus so arranged that, before being received into the cooling drum 5, the casting is ground into substantially the same size.

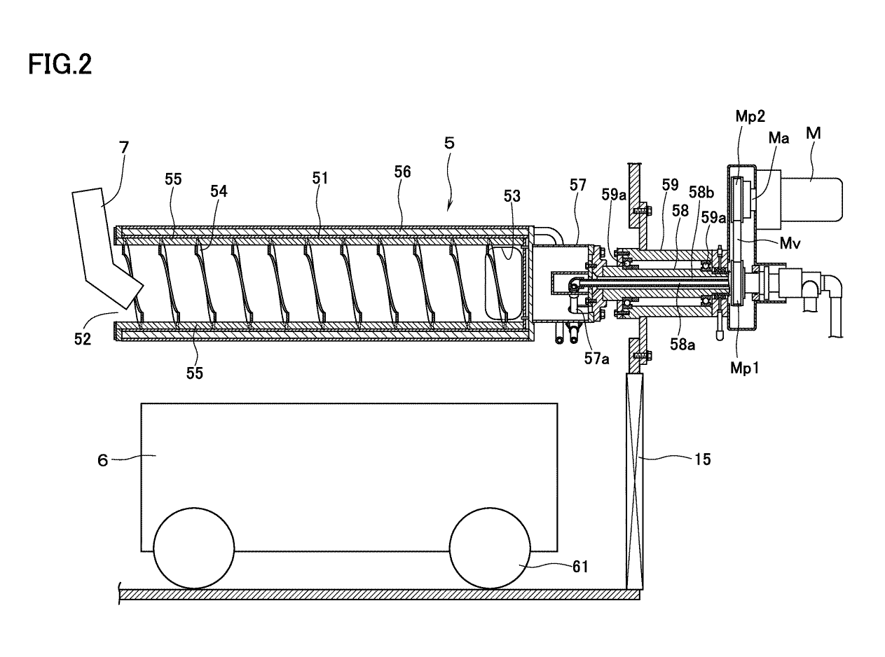

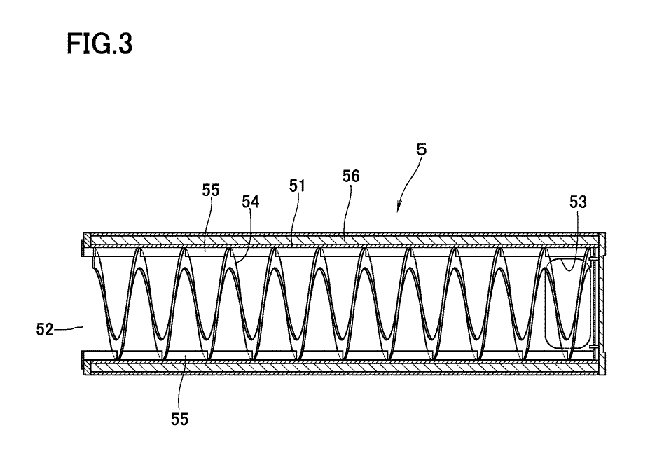

As shown in FIGS. 2 and 3, the cooling drum 5 is provided with a tubular member 51 which is elongated in one direction. The tubular member 51 is supported in a cantilevered manner by the right side wall of the sub-container portion 1b so as to be housed in a horizontal posture inside the subsidiary container portion 12. On the left end surface of the tubular member 51, there is provided the receiving opening 52 to receive the front end of the trough 7 that is inserted into the receiving opening 52. At the same time, on the peripheral surface of the right end of the tubular member 51, there are provided two discharge openings 53 for discharging the casting that has been subjected to secondary cooling, the discharge openings 53 being arranged at a peripheral distance of 180 degrees from each other. In addition, on the inner peripheral surface of the tubular member 51 there is provided a first projecting strip 54, in helical manner, over a substantially entire longitudinal length of the tubular member 51. Also there are provided two second linear projecting strips 55 at a circumferential distance of 180 degrees from each other. In this embodiment, the first projecting strip 54 and the second projecting strips 55 in the rotatable tubular member 51 constitute the transfer means. When the cooling drum 5 is rotated in one direction of rotation, the casting is efficiently and sequentially transferred by a predetermined amount at a time from the receiving opening 52 side toward the discharge openings 53 side by means of the first projecting strip 54 and the second projecting strips 55. In this case, the tubular member 51 is rotated at a rotational speed of 1 to 60 rpm in response to the temperature and the like of the casting to be subjected to secondary cooling. Further, the outer peripheral surface of the tubular member 51 is provided with a cooling jacket 56. It is thus so arranged that the inner surface of the tubular member 51 can be cooled by circulating a cooling medium (e.g., cooling water). Still furthermore, the main container portion 1a is provided with a gas pipe 9 of a cooling gas introducing means which is communicated with a supply source of a cooling gas such as argon gas, helium gas and the like for accelerating the secondary cooling of the casting and which introduces the cooling gas toward the receiving opening 52.

On the right end surface of the tubular member 51 there is formed a joint portion 57. The joint portion 57 is connected to a rotary shaft 58 which penetrates through the side surface of the sub-container portion 1b. The rotary shaft 58 is supported, via bearings 59a, by a cylindrical supporting member 59 which is provided on the side surface of the sub-container 1b. Inside the rotary shaft 58 there are formed a forward circulation passage 58a for a cooling medium, and a return circulation passage 58b which is formed around the forward circulation passage 58a. It is thus so arranged that the cooling medium can be circulated in a cooling jacket 56 through a connecting pipe 57a which is disposed inside a joint portion 57. Further, the rotary shaft 58 is coupled to a pulley Mp1 provided on an end portion of the rotary shaft 58. By means of a belt Mv wound around the pulley Mp1 and a pulley Mpg that is provided on a rotary shaft Ma of a motor M which is disposed on an outside of the sub-container 1b, the rotary drum 5 is arranged to be rotatable by the motor M in one direction of rotation. By the way, the length and the diameter of the tubular member 51, and the pitch of the first projecting strip 54 may be appropriately set out of consideration of the rotational speed of the cooling roll 4, the temperature to which the casting shall be cooled, and the like.

The recovery box 6 is disposed inside the sub-container 1b right below the discharge openings 53 of the cooling drum 5 so as to receive and recover the casting that drops from the discharge opening 53. The recovery box 6 is provided with casters 61, and the right-side wall of the sub-container 1b is provided, on its lower side, with an open-close door 15. The recovery box 6 is thus arranged to be movable into and out of the sub-container 1b.

According to the above-mentioned embodiment, the casting as received into the tubular member 51 is sequentially transferred from the receiving opening 52 side toward the discharge openings 53 side in response to the number of rotation of the tubular member 51. In the course of this transfer process, the casting is subjected to the secondary cooling by heat exchanging with the inner peripheral surface of the tubular member 51 before being discharged out of the discharge openings 53. Therefore, unlike the above-mentioned conventional example in which the casting is stored once, the casting can be cooled substantially uniformly. In addition, by changing the number of rotation of the tubular member 51, the cooling speed can also be changed. Still furthermore, without being bound by the productivity, the tubular member 51 is required only to have the length and inner diameter depending on the temperature to which the casting shall be cooled. Supported by the feature that the vacuum melting and casting apparatus is provided with the cooling gas introducing means, the tubular member 51 can be made smaller in length and diameter. Further downsizing of the vacuum melting and casting apparatus becomes possible.

Furthermore, since the tubular member 51 is provided, on its inner surface, with the first projecting strip 54 and the second projecting strips 55, the casting received into the tubular member 51 is prevented from locally staying inside the tubular member 51. Therefore, a predetermined amount of the casting can be sequentially and efficiently transferred from the receiving openings 52 side toward the discharge openings 53 side. Still furthermore, by providing the vacuum melting and casting apparatus with the grinding means 8, the casting can be ground to a substantially uniform size before being received by the tubular member 51, the casting can be subjected to secondary cooling in a further uniform manner.

Descriptions have so far been made of an embodiment of this invention, but this invention shall not be limited to the above. In the above embodiment, descriptions have been made of an example in which the inner peripheral surface of the tubular member 51 is provided with the transfer means comprising the first projecting strip 54 disposed spirally and the two second projecting strips 55 disposed linearly. However, any mode will do as long as a predetermined amount of casting can be sequentially transferred efficiently from the receiving opening 52 side toward the discharge openings 53 side. Further, ring-shaped eccentric members are respectively disposed on the inner surface of the tubular member 51 at a predetermined spacing so as to form the first projecting strip 54 as a whole. They shall, however, not be limited to the above, but may be formed integrally. Further, a description has been made of an example in which the tubular member 51 is horizontally supported in a cantilevered manner by the wall surface of the sub-container portion 1b. It may, alternatively, be so arranged that supporting rollers which support the peripheral surface of the tubular member 51 are disposed on the sub-container 1b. Still furthermore, the tubular member 51 may be disposed in a manner to be inclined downward toward the right-hand side so that the casting can be efficiently and sequentially transferred from the receiving opening 52 side toward the discharge openings 53 side. In this case, the tubular member 51 itself constitutes the transfer means.

### EXPLANATION OF REFERENCE NUMERALS

CM vacuum melting and casting apparatus
1 hermetically sealed container
2 melting furnace
4 cooling roll
5 cooling drum
51 tubular member (cooling drum)
52 receiving opening
53 discharge opening
54 first projecting strip (transfer means)
55 second projecting strip (transfer means)
8 grinding means
9 gas pipe (cooling gas introducing means)

1. A vacuum melting and casting apparatus having, inside a hermetically sealed container to which an evacuating pipe is connected:
a melting furnace;
a cooling roll for forming a casting by subjecting molten metal tapped from the melting furnace to primary cooling; and
a rotatable cooling drum for receiving the casting formed by the cooling roll and for subjecting the casting to secondary cooling;
wherein the cooling drum comprises:
a tubular member elongated in one longitudinal direction and having a receiving opening which is formed to open on one side of the tubular member in order to receive therein the casting, and a discharge opening which is formed to open on an opposite side of the tubular member in order to discharge the casting that has been subjected to the secondary cooling; and
a transfer means for transferring the casting received from the receiving opening toward the discharge opening in response to the rotation of the tubular member.

2. The vacuum melting and casting apparatus according to claim 1, wherein the transfer means is characterized in having: a first projecting strip disposed spirally on an inner peripheral surface of the tubular member; and at least one second projecting strip disposed linearly on the inner peripheral surface of the tubular member.

3. The vacuum melting and casting apparatus according to claim 1, characterized in that a grinding means is further provided for grinding, before transferring to the receiving opening, the casting which has been subjected to primary cooling by the cooling roll.

4. The vacuum melting and casting apparatus according to claim 1, wherein the tubular member is further provided with a cooling gas introducing means for introducing a cooling gas to accelerate the secondary cooling of the casting inside the tubular member.

5. The vacuum melting and casting apparatus according to claim 2, wherein a grinding means is further provided for grinding, before transferring to the receiving opening, the casting which has been subjected to primary cooling by the cooling roll.

6. The vacuum melting and casting apparatus according to claim 2, wherein the tubular member is further provided with a cooling gas introducing means for introducing a cooling gas to accelerate the secondary cooling of the casting inside the tubular member.

7. The vacuum melting and casting apparatus according to claim 3, wherein the tubular member is further provided with a cooling gas introducing means for introducing a cooling gas to accelerate the secondary cooling of the casting inside the tubular member.
